(19) United States
(12) Patent Application Publication
(10) Pub. No.: US 2010/0302653 A1
(43) Pub. Date: Dec. 2, 2010

(54) LENS SYSTEM

(75) Inventors: KUO-YEN LIANG, Tu-Cheng (TW); CHUN-HSIANG HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/508,593

(22) Filed: Jul. 24, 2009

(30) Foreign Application Priority Data
Jun. 2, 2009 (CN) 200910302836.6

(51) Int. Cl. G02B 13/18; G02B 9/34

(52) U.S. Cl. 359/715; 359/773; 359/738

(57) ABSTRACT

A lens system includes, in order from the object side, a positive refractive power first lens, a negative refractive power second lens, a positive refractive power third lens, and a negative refractive power fourth lens. The lens system satisfies the following conditions: D/L>1.18; and L/T2>14. Wherein, D is the diameter of the effective imaging area of the lens system on the image plane, L is a distance from a surface of the first lens facing the object side of the lens system to the image plane, and T2 is a distance between the two surfaces of the second lens on the optical axis of the lens system.

### BACKGROUND

1. Technical Field

The present invention relates to a lens system and, particularly, to a compact lens system having a small number of lens components and a short overall length.

2. Description of Related Art

Conventionally, lens systems with short overall length are demanded for use in lens modules for image acquisition that are mounted in relatively compact equipment, such as simple digital cameras, webcams for personal computers, and portable imaging systems in general. However, the resolution of the lens system usually decreases with the decreasing of the number of the lenses of the lens system.

What is needed, therefore, is a lens system with a short overall length and with relatively good optical performance.

### BRIEF DESCRIPTION OF THE DRAWINGS

Many aspects of the present lens system can be better understood with reference to the accompanying drawings. The components in the drawings are not necessarily drawn to scale, the emphasis instead being placed upon clearly illustrating the principles of the present lens system. In the drawings, all the views are schematic.

FIG. 1 is a schematic view of a lens system according to an exemplary embodiment.

FIGS. 2-4 are graphs respectively showing field curvature, distortion, and spherical aberration for a lens system according to a first exemplary embodiment.

FIGS. 5-7 are graphs respectively showing field curvature, distortion and spherical aberration for a lens system according to a second exemplary embodiment.

FIGS. 8-10 are graphs respectively showing field curvature, distortion and spherical aberration for a lens system according to a third exemplary embodiment.

### DETAILED DESCRIPTION

Embodiments of the present disclosure will now be described in detail below, with reference to the accompanying drawings.

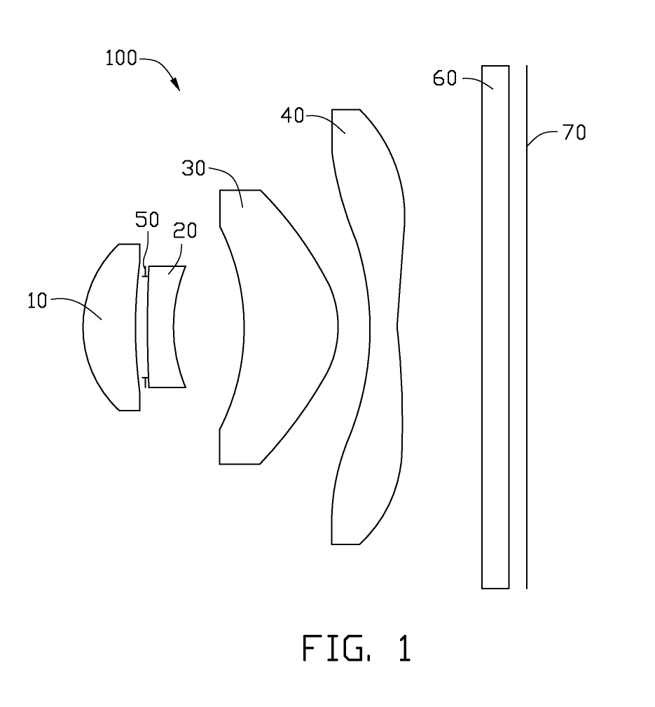

Referring to FIG. 1, a lens system 100, according to an exemplary embodiment, is shown. The lens system 100 includes, in order from the object side to the image side, a positive refractive power first lens 10, a negative refractive power second lens 20, a positive refractive power third lens 30, and a negative refractive power fourth lens 40. The lens system 100 can be used in digital cameras, mobile phones, personal computer cameras and so on. The lens system 100 can be used for capturing images by disposing an image sensor at an image plane 70 of the lens system 100.

In order that the lens system 100 has a short overall length and low spherical aberration, the lens system 100 satisfies the following conditions:

D/L>1.18; and (1)

L/T2>14, (2)

Wherein, D is the diameter of the effective imaging area of the lens system 100 on the image plane 70, L is a distance from a surface of the first lens 10 facing the object side of the lens system 100 to the image plane 70, and T2 is a distance between the two surfaces of the second lens 20 on the optical axis of the lens system 100. The first condition (1) is for limiting the overall length of the lens system 100 by providing the relationship between the overall length of the lens system 100 and the diameter of the effective imaging area of the lens system 100 on the image plane 70. The second condition (2) is for decreasing spherical aberration of the lens system 100 by limiting the relationship between the overall length of the lens system 100 and the distance between the two surfaces of the second lens 20 on the optical axis of the lens system 100.

The first lens 10 also satisfies the following conditions:

0.25<F/G1R1<0.45; and (3)

vd1>50, (4)

wherein, F is a focal length of the lens system 100, G1R1 is the radius of curvature of a surface of the first lens 10 facing the object side of the lens system 100, and vd1 is the Abbe constant of the first lens 10. The third condition (3) is configured for decreasing spherical aberration and coma of the lens system 100. The fourth condition (4) is for ensuring the light from an object has low chromatic aberration after transmitting through the first lens 10 to decrease the chromatic aberration of the lens system 100. In the present embodiment, the first lens 10 is a meniscus-shaped lens with a convex surface facing the object side of the lens system 100 and the two surfaces of the first lens 10 are aspherical.

The second lens 20 also satisfies the following conditions:

vd2<32; and (5)

−1.5<F2/F<−0.9, (6)

wherein, vd2 is the Abbe constant of the second lens 20, and F2 is a focal length of the second lens 20. The fifth condition (5) is for ensuring the light from an object has low chromatic aberration after transmitting through the second lens 20 to decrease the chromatic aberration of the lens system 100. The sixth condition (6) is configured for decreasing spherical aberration and coma of the lens system 100 by limiting the relationship between the focal length of the second lens 20 and the focal length of the lens system 100. In the present embodiment, the two surfaces of the second lens 20 are aspherical.

The third lens 30 also satisfies the following condition:

−1<G3R1/F<−0.5<G3R2/F<−0.15, (7)

wherein, G3R1 is the radius of curvature of a surface of the third lens 30 facing the object side of the lens system 100, and G3R2 is the radius of curvature of a surface of the third lens 30 facing the image side of the lens system 100. The seventh condition (7) can decrease spherical aberration and coma of the lens system 100. In the present embodiment, the third lens 30 is a meniscus-shaped lens with a convex surface facing the image side of the lens system 100 and the two surfaces of the third lens 30 are aspherical.

In the present embodiment, the lens surface configuration of the fourth lens 40 near the optical axis of the lens system 100 is bi-concave and the two surfaces of the fourth lens 40 are aspherical. The fourth lens 40 can decrease astigmation and coma of the lens system 100.

The lens system 100 further includes an aperture stop 50 and an infrared filter 60. The aperture stop 50 is arranged between the first lens 10 and the second lens 20 in order to reduce light flux into the second lens 20. For cost reduction, the aperture stop 50 may be formed directly on the surface of the second lens 20 facing the object side of the lens system 100. In practice, a portion of the surface of the second lens 10 through which light rays should not be transmitted is coated with an opaque material, which functions as the aperture stop 50. The infrared filter 60 is arranged between the fourth lens 40 and the image plane 70 for filtering infrared rays coming into the lens system 100.

Further, the first lens 10, the second lens 20, the third lens 30, and the fourth lens 40 can be made of a resin or a plastic, which makes their manufacture relatively easy and inexpensive.

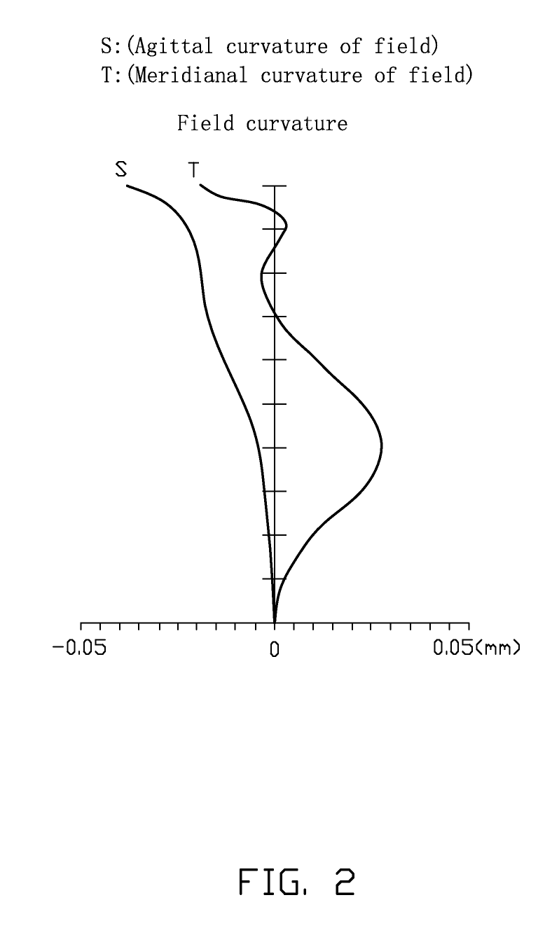

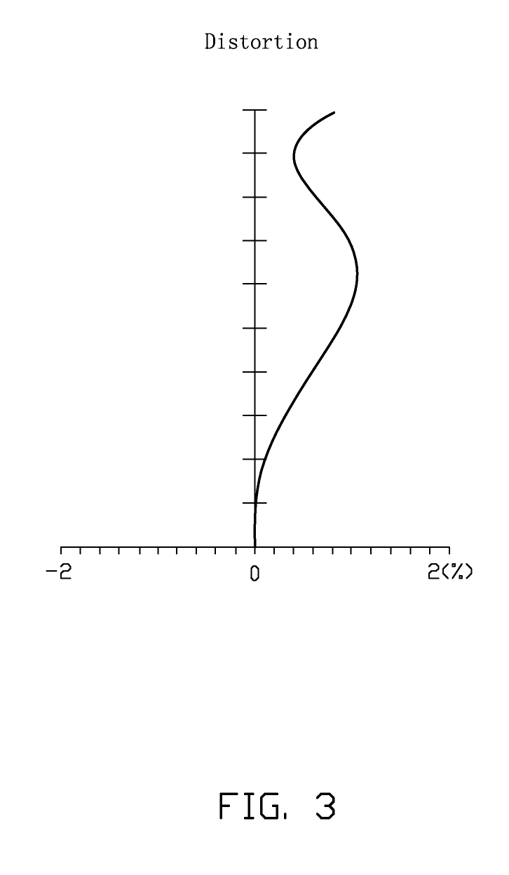

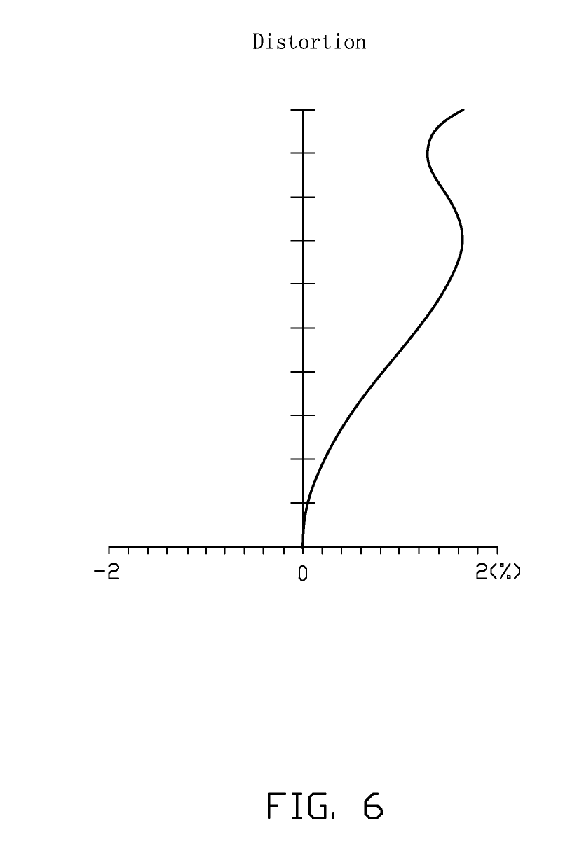

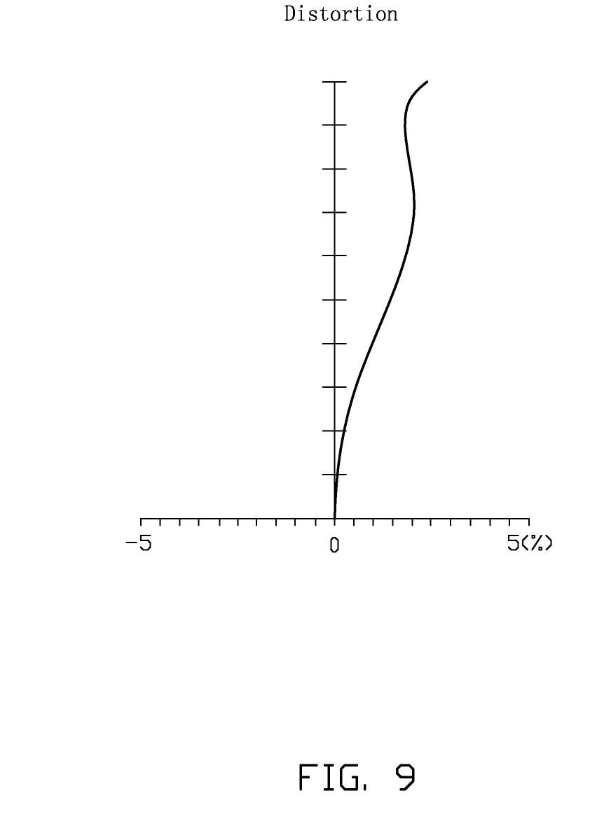

Examples of the system will be described below with reference to FIGS. 2-10. It is to be understood that the invention is not limited to these examples. The following are symbols used in each exemplary embodiment.

R: radius of curvature

d: distance between surfaces on the optical axis of the system

nd: refractive index of lens

V: Abbe constant

In each example, both surfaces of the first lens 10, both surfaces of the second lens 20, both surfaces of the third lens 30 are aspheric, and both surfaces of the fourth lens 40 are aspheric. The shape of each aspheric surface is determined by expression 1 below. Expression 1 is based on a Cartesian coordinate system, with the vertex of the surface being the origin, and the optical axis extending from the vertex being the x-axis.

$$x = \frac{{ch}^{2}}{1 + \sqrt{1 - ( k + 1 ) {c}^{2} {h}^{2}}} + \sum {A}_{i} {h}^{i} \qquad Expression 1$$

wherein, h is a height from the optical axis to the surface, c is a vertex curvature, k is a conic constant, and Ai are i-th order correction coefficients of the aspheric surfaces.

### EXAMPLE 1

Tables 1 and 2 show lens data of Example 1. In the table 2, A4 to A12 are aspherical coefficients. The field angle of the lens system 100 is 68.7°.

TABLE 1

| Lens system 100 | R(mm) | d(mm) | nd | V |
|---|---|---|---|---|
| Object side surface of the first lens 10 | 1.376 | 0.546 | 1.55 | 58 |
| Image side surface of the first lens 10 | 9.287 | 0.099 | — | — |
| Aperture stop | infinite | 0.017 | — | — |
| Object side surface of the second lens 20 | 5.935 | 0.280 | 1.62 | 22 |
| Image side surface of the second lens 20 | 2.044 | 0.777 | — | — |
| Object side surface of the third lens 30 | −2.551 | 0.946 | 1.55 | 52 |
| Image side surface of the third lens 30 | −1.006 | 0.397 | — | — |
| Object side surface of the fourth lens 40 | −2.918 | 0.320 | 1.52 | 52 |
| Image side surface of the fourth lens 40 | 2.680 | 1.094 | — | — |
| Object side surface of the infrared filter 60 | infinite | 0.300 | 1.517 | 64 |
| Image side surface of the infrared filter 60 | infinite | 0.020 | — | — |

TABLE 2

| Surface | Aspherical coefficients |
|---|---|
| Object side surface of the first lens | A4 = 0.0070; A6 = 0.0307; |
| 10 | A8 = −0.0005; A10 = −0.0110; |
| | A12 = 0.0503 |
| Image side surface of the first lens | A4 = 0.0695; A6 = −0.0466; |
| 10 | A8 = 0.0748; A10 = −0.1055; |
| | A12 = 0.0330 |
| Object side surface of the second | A4 = 0.0507; A6 = −0.1345; |
| lens 20 | A8 = 0.0087; A10 = −0.1599; |
| | A12 = 0.0700 |
| Image side surface of the second lens | A4 = 0.0655; A6 = −0.0545; |
| 20 | A8 = −0.0205; A10 = 0.0164; |
| | A12 = 0.0489 |
| Object side surface of the third lens | A4 = −0.0806; A6 = 0.0472; |
| 30 | A8 = −0.0176; A10 = −0.0351; |
| | A12 = 0.0358 |
| Image side surface of the third lens | A4 = −0.0814; A6 = 0.0164; |
| 30 | A8 = −0.0052; A10 = 0.0047; |
| | A12 = −0.0004 |
| Object side surface of the fourth lens | A4 = −0.0253; A6 = 0.0038; |
| 40 | A8 = 0.0016; A10 = −0.0004; |
| | A12 = 0.000028 |
| Image side surface of the fourth lens | A4 = −0.0458; A6 = 0.0085; |
| 40 | A8 = −0.0021; A10 = 0.0002; |
| | A12 = −0.0000049 |

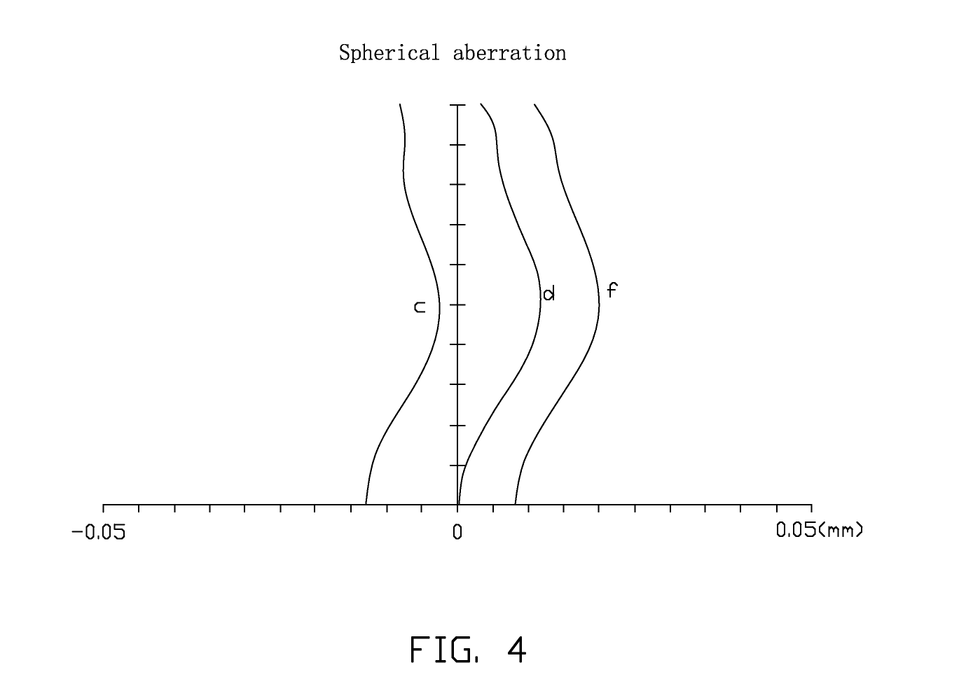

FIGS. 2-4 are graphs of aberrations (distortion, field curvature, and spherical aberration) of the lens system 100 of Example 1. In FIG. 4, the curves c, d, and f show spherical aberrations of the lens system 100 corresponding to three light wavelengths of 656.3 nm, 587.6 nm, and 435.8 nm, respectively. Generally, the field curvature of the lens system 100 is limited to a range from −0.05 mm to 0.05 mm, the distortion of the lens system 100 is limited to a range from −2% to 2%, and the spherical aberration of lens system 100 is limited to a range from −0.05mm to 0.05 mm.

### EXAMPLE 2

Tables 3 and 4 show lens data of Example 2. In the table 4, A4 to A12 are aspherical coefficients. The field angle of the lens system 100 is 68.3°.

TABLE 3

| Lens system 100 | R(mm) | d(mm) | nd | V |
|---|---|---|---|---|
| Object side surface of the first lens 10 | 1.403 | 0.579 | 1.57 | 57 |
| Image side surface of the first lens 10 | 11.061 | 0.119 | — | — |
| Aperture stop | infinite | 0.010 | — | — |
| Object side surface of the second lens 20 | 10.794 | 0.308 | 1.64 | 23 |
| Image side surface of the second lens 20 | 2.321 | 0.782 | — | — |
| Object side surface of the third lens 30 | −3.435 | 1.047 | 1.56 | 48 |
| Image side surface of the third lens 30 | −1.052 | 0.375 | — | — |
| Object side surface of the fourth lens 40 | −2.186 | 0.300 | 1.51 | 49 |
| Image side surface of the fourth lens 40 | 2.809 | 0.957 | — | — |
| Object side surface of the infrared filter 60 | infinite | 0.300 | 1.517 | 64 |
| Image side surface of the infrared filter 60 | infinite | 0.020 | — | — |

TABLE 4

| Surface | Aspherical coefficients |
|---|---|
| Object side surface of the first lens | A4 = 0.0059; A6 = 0.0260; |
| 10 | A8 = 0.0018; A10 = −0.0127; |
| | A12 = 0.0414 |
| Image side surface of the first lens | A4 = 0.0667; A6 = −0.0410; |
| 10 | A8 = 0.0879; A10 = −0.0970; |
| | A12 = 0.0146 |
| Object side surface of the second | A4 = 0.0693; A6 = −0.1188; |
| lens 20 | A8 = 0.0395; A10 = −0.1375; |
| | A12 = 0.0532 |
| Image side surface of the second lens | A4 = 0.0835; A6 = −0.0579; |
| 20 | A8 = 0.0099; A10 = 0.0184; |
| | A12 = 0.0092 |
| Object side surface of the third lens | A4 = −0.0733; A6 = 0.0357; |
| 30 | A8 = −0.0053; A10 = −0.0379; |
| | A12 = 0.0244 |
| Image side surface of the third lens | A4 = −0.0654; A6 = 0.0202; |
| 30 | A8 = −0.0083; A10 = 0.0036; |
| | A12 = −0.0004 |
| Object side surface of the fourth lens | A4 = −0.0196; A6 = 0.0035; |
| 40 | A8 = 0.0015; A10 = −0.0004; |
| | A12 = 0.0000285 |
| Image side surface of the fourth lens | A4 = −0.0424; A6 = 0.0090; |
| 40 | A8 = −0.0022; A10 = 0.0002; |
| | A12 = −0.0000061 |

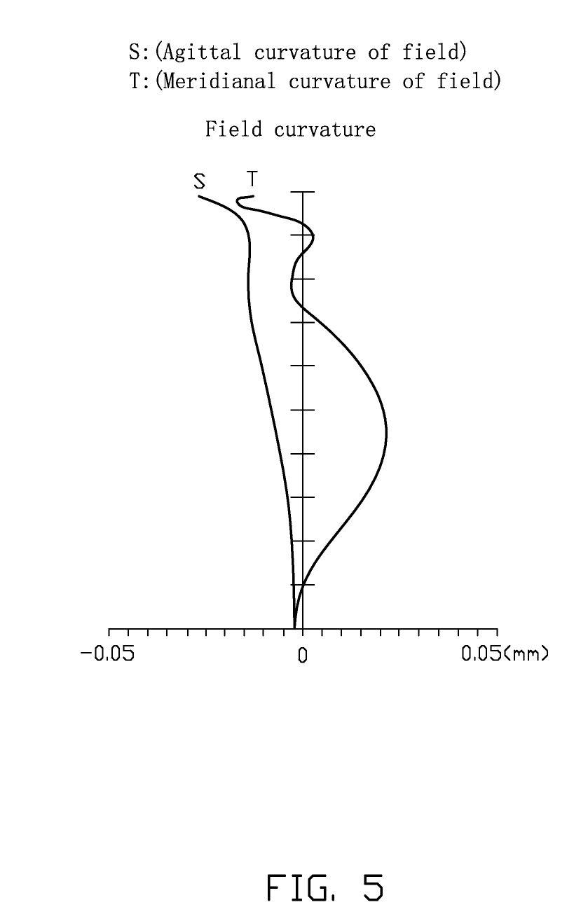

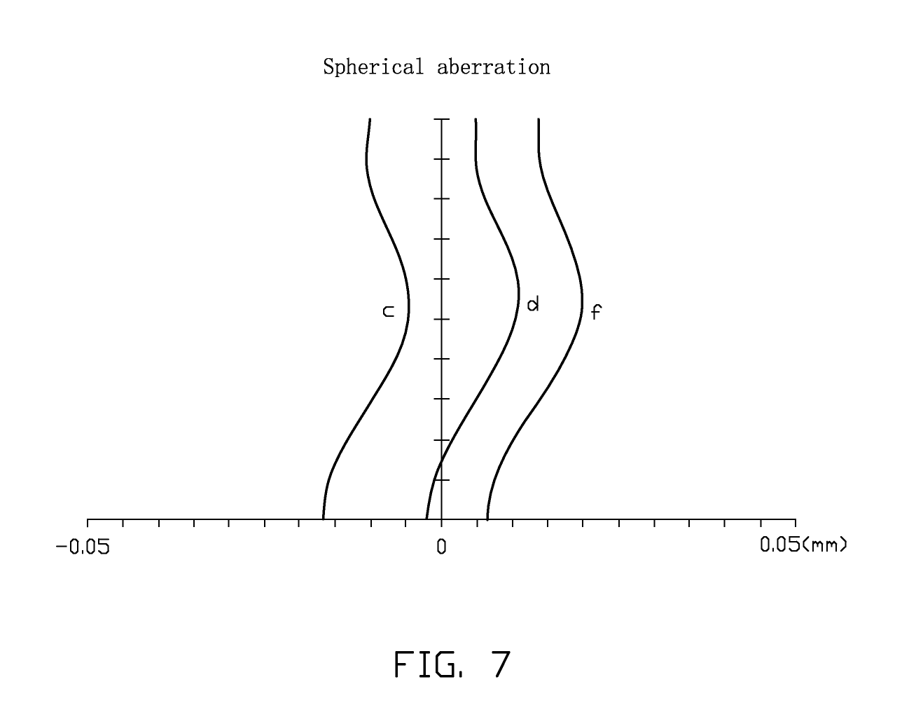

FIGS. 5-7 are graphs of aberrations (distortion, field curvature, and spherical aberration) of the lens system 100 of Example 1. In FIG. 7, the curves c, d, and f show spherical aberrations of the lens system 100 corresponding to three light wavelengths of 656.3 nm, 587.6 nm, and 435.8 nm, respectively. Generally, the field curvature of the lens system 100 is limited to a range from −0.05 mm to 0.05 mm, the distortion of the lens system 100 is limited to a range from −2% to 2%, and the spherical aberration of lens system 100 is limited to a range from −0.05 mm to 0.05 mm.

### EXAMPLE 3

Tables 5 and 6 show lens data of Example 3. In the table 6, A4 to A12 are aspherical coefficients. The field angle of the lens system 100 is 68.2°.

TABLE 5

| Lens system 100 | R(mm) | d(mm) | nd | V |
|---|---|---|---|---|
| Object side surface of the first lens 10 | 1.400 | 0.572 | 1.56 | 60 |
| Image side surface of the first lens 10 | 12.017 | 0.111 | — | — |
| Aperture stop | infinite | 0.010 | — | — |
| Object side surface of the second lens 20 | 8.998 | 0.301 | 1.62 | 25 |
| Image side surface of the second lens 20 | 2.172 | 0.782 | — | — |
| Object side surface of the third lens 30 | −2.997 | 0.961 | 1.54 | 50 |
| Image side surface of the third lens 30 | −1.058 | 0.422 | — | — |
| Object side surface of the fourth lens 40 | −3.330 | 0.300 | 1.51 | 50 |
| Image side surface of the fourth lens 40 | 2.369 | 0.979 | — | — |
| Object side surface of the infrared filter 60 | infinite | 0.300 | 1.517 | 64 |
| Image side surface of the infrared filter 60 | infinite | 0.020 | — | — |

TABLE 6

| Surface | Aspherical coefficients |
|---|---|
| Object side surface of the first lens | A4 = 0.0059; A6 = 0.0271; |
| 10 | A8 = 0; A10 = −0.0108; |
| | A12 = 0.0426 |
| Image side surface of the first lens | A4 = 0.0653; A6 = −0.0412; |
| 10 | A8 = 0.0869; A10 = −0.1009; |
| | A12 = 0.0228 |
| Object side surface of the second | A4 = 0.0557; A6 = −0.1144; |
| lens 20 | A8 = 0.0403; A10 = −0.1406; |
| | A12 = 0.0541 |
| Image side surface of the second lens | A4 = 0.0680; A6 = −0.0485; |
| 20 | A8 = 0.0047; A10 = 0.0170; |
| | A12 = 0.0161 |
| Object side surface of the third lens | A4 = −0.0766; A6 = 0.0401; |
| 30 | A8 = −0.0150; A10 = −0.0365; |
| | A12 = 0.0296 |
| Image side surface of the third lens | A4 = −0.0711; A6 = 0.0161; |
| 30 | A8 = −0.0078; A10 = 0.0038; |
| | A12 = −0.0003 |
| Object side surface of the fourth lens | A4 = −0.0240; A6 = 0.0036; |
| 40 | A8 = 0.0016; A10 = −0.0004; |
| | A12 = 0.0000287 |
| Image side surface of the fourth lens | A4 = −0.0418; A6 = 0.0087; |
| 40 | A8 = −0.0021; A10 = 0.0002; |
| | A12 = 0.000007 |

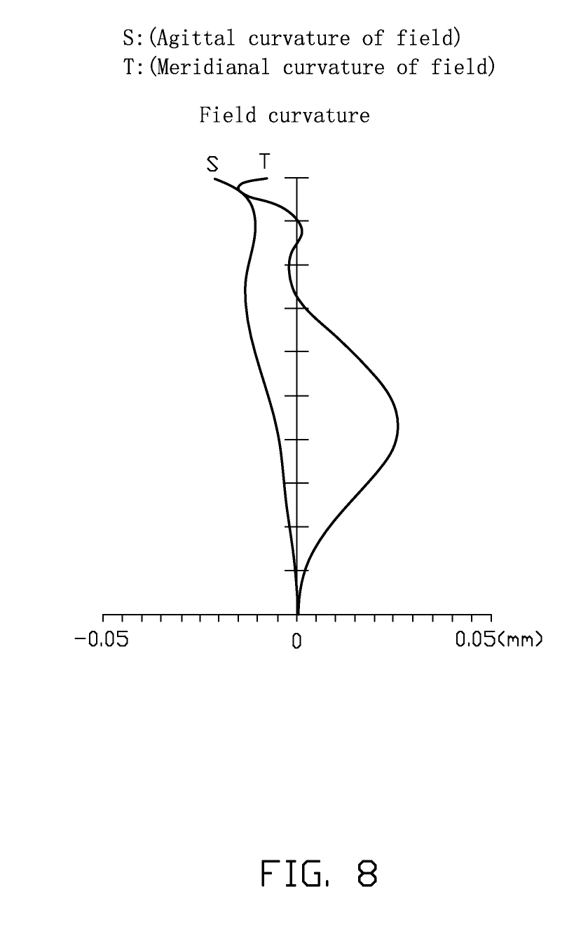

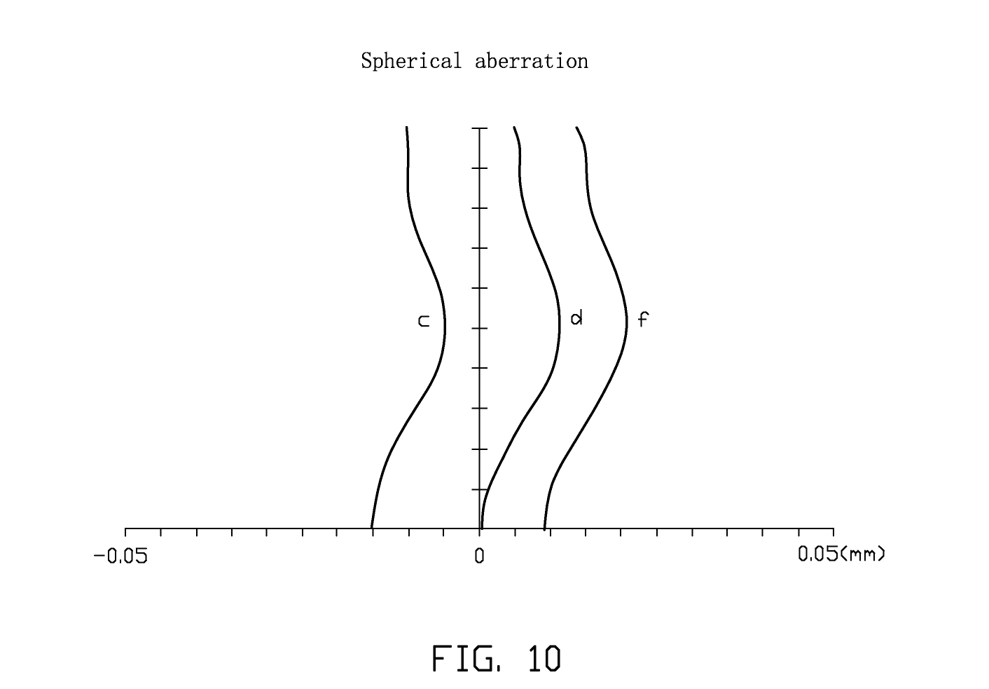

FIGS. 8-10 are graphs of aberrations (distortion, field curvature, and spherical aberration) of the lens system 100 of Example 1. In FIG. 10, the curves c, d, and f show spherical aberrations of the lens system 100 corresponding to three light wavelengths of 656.3 nm, 587.6 nm, and 435.8 nm, respectively. Generally, the field curvature of the lens system 100 is limited to a range from −0.05 mm to 0.05 mm, the distortion of the lens system 100 is limited to a range from −2% to 2%, and the spherical aberration of lens system 100 is limited to a range from −0.05 mm to 0.05 mm.

As seen in the above-described examples, the distortion of the lens system 100 can also be limited to a range from −2% to 2%. The overall length of the lens system 100 is small, and the system 100 appropriately corrects fundamental aberrations.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A lens system comprising, in order from the object side:
a positive refractive power first lens;
a negative refractive power second lens;
a positive refractive power third lens; and
a negative refractive power fourth lens,
wherein the lens system satisfies the following conditions:
D/L>1.18; and (1)
L/T2>14, (2)
wherein, D is the diameter of the effective imaging area of the lens system on the image plane, L is a distance from a surface of the first lens facing the object side of the lens system to the image plane, and T2 is a distance between the two surfaces of the second lens on the optical axis of the lens system.

2. The lens system as claimed in claim 1, wherein the following conditions are satisfied: (3) 0.25<F/G1R1<0.45; and (4) vd1>50, wherein, F is a focal length of the lens system, G1R1 is the radius of curvature of a surface of the first lens facing the object side of the lens system, and vd1 is the Abbe constant of the first lens.

3. The lens system as claimed in claim 1, wherein the following conditions are satisfied: (5) vd2<32; and (6) −1.5<F2/F<−0.9, wherein, vd2 is the Abbe constant of the second lens; F2 is a focal length of the second lens; and F is a focal length of the lens system.

4. The lens system as claimed in claim 1, wherein the following condition is satisfied: (7) −1<G3R1/F<−0.5<G3R2/F<−0.15, wherein, G3R1 is the radius of curvature of a surface of the third lens facing the object side of the lens system; F is a focal length of the lens system; and G3R2 is the radius of curvature of a surface of the third lens facing the image side of the lens system.

5. The lens system as claimed in claim 1, further comprising an aperture stop arranged between the first lens and the second lens.

6. The lens system as claimed in claim 5, wherein the aperture stop is formed directly on the surface of the second lens facing the object side of the lens system.

7. The lens system as claimed in claim 6, wherein the aperture stop is formed by coating a peripheral portion of the surface of the second lens using an opaque material.

8. The lens system as claimed in claim 1, wherein the first lens, the second lens, the third lens, and the fourth lens are made of a resin or a plastic.

9. The lens system as claimed in claim 1, wherein the lens system further comprises an infrared filter arranged between the fourth lens and the image plane of the lens system.

10. The lens system as claimed in claim 1, wherein the first lens is a meniscus-shaped lens with a convex surface facing the object side of the lens system.

11. The lens system as claimed in claim 1, wherein two surfaces of the first lens are aspherical.

12. The lens system as claimed in claim 1, wherein the two surfaces of the second lens are aspherical.

13. The lens system as claimed in claim 1, wherein the third lens is a meniscus-shaped lens with a convex surface facing the image side of the lens system.

14. The lens system as claimed in claim 1, wherein the two surfaces of the third lens are aspherical.

15. The lens system as claimed in claim 1, wherein the lens surface configuration of the fourth lens near the optical axis of the lens system is bi-concave.

16. The lens system as claimed in claim 1, wherein the two surfaces of the fourth lens are aspherical.

17. An image capturing device comprising:
a lens system comprising, in order from the object side:
a positive refractive power first lens;
a negative refractive power second lens;
a positive refractive power third lens;
a negative refractive power fourth lens; and
aperture stop arranged between the first lens and the second lens,
wherein the lens system satisfies the following conditions:
D/L>1.18; and (1)
L/T2>14, (2)
wherein, D is the diameter of the effective imaging area of the lens system on the image plane, L is a distance from a surface of the first lens facing the object side of the lens system to the image plane, and T2 is a distance between the two surfaces of the second lens on the optical axis of the lens system.

18. The image capturing device as claimed in claim 17, wherein the following conditions are further satisfied: (3) 0.25<F/G1R1<0.45; and (4) vd1>50, wherein, F is a focal length of the lens system, G1R1 is the radius of curvature of a surface of the first lens facing the object side of the lens system, and vd1 is the Abbe constant of the first lens.

19. The image capturing device as claimed in claim 17, wherein the following conditions are further satisfied: (5) vd2<32; and (6) −1.5<F2/F<−0.9, wherein, vd2 is the Abbe constant of the second lens; F2 is a focal length of the second lens; and F is a focal length of the lens system.

20. The lens system as claimed in claim 17, wherein the following condition is further satisfied: (7) −1<G3R1/F<−0.5<G3R2/F<−0.15, wherein, G3R1 is the radius of curvature of a surface of the third lens facing the object side of the lens system; F is a focal length of the lens system; and G3R2 is the radius of curvature of a surface of the third lens facing the image side of the lens system.
